(19) United States
(12) Patent Application Publication
(10) Pub. No.: US 2025/0322146 A1
(43) Pub. Date: Oct. 16, 2025

(54) ANNOTATING EVENT IN APPLICATION

(71) Applicant: TENCENT TECHNOLOGY (SHENZHEN) COMPANY LIMITED, Shenzhen (CN)

(72) Inventors: Yang LIU, Shenzhen (CN); Yifei BAI, Shenzhen (CN); Kunli DENG, Shenzhen (CN); Canhui HUANG, Shenzhen (CN)

(73) Assignee: TENCENT TECHNOLOGY (SHENZHEN) COMPANY LIMITED, Shenzhen (CN)

(21) Appl. No.: 19/248,313

(22) Filed: Jun. 24, 2025

Related U.S. Application Data
(63) Continuation of application No. PCT/CN2024/084299, filed on Mar. 28, 2024.

(30) Foreign Application Priority Data
May 23, 2023 (CN) 202310591425.3

(51) Int. Cl. G06F 40/169; G06F 3/04842; G06F 9/455

(52) U.S. Cl. CPC G06F 40/169; G06F 3/04842; G06F 9/455

(57) ABSTRACT

A user interface of an event annotating tool is displayed in a browser. In response to a start operation, a user interface of an application experience simulator of the application is displayed in the user interface of the event annotating tool. When the application experience simulator enters an element selection mode, in response to a selection operation of a first element in the user interface of the application experience simulator, event annotating information related to the first element is displayed in the user interface of the event annotating tool. The event annotating information includes at least an interaction type and/or a display feature of an element related to the first element. In response to a confirmation operation on the event annotating information, one or more operation events that occur in the application corresponding to the application experience simulator and match the event annotating information are annotated.

### RELATED APPLICATIONS

The present application is a continuation of International Application No. PCT/CN2024/084299, filed on Mar. 28, 2024, which claims priority to Chinese Patent Application 202310591425.3, filed on May 23, 2023. The entire disclosures of the prior applications are hereby incorporated by reference.

### FIELD OF THE TECHNOLOGY

Embodiments of this disclosure relate to the field of application technologies, including a method and apparatus for annotating an event in an application.

### BACKGROUND OF THE DISCLOSURE

After an application is launched, an analyst usually needs to collect statistics and analysis on object behaviors of the application, to obtain user use statuses of the application and provide data support for subsequent operation and optimization of the application.

In a related technology, data is collected by embedding a code. Code embedding is to implant code at events needing to be counted in an application, so as to count a quantity of object behaviors such as a quantity of clicks/taps, a quantity of visitors, a page dwell time, and a video playback duration. During the code embedding, the analyst first needs to determine the requirement of an embedded code, that is, an event to be acquired, an object behavior to be counted, and the like. Subsequently, the analyst communicates with a developer of the application for the requirement of the embedded code, and the developer implements the code embedding. Then, the analyst, or the developer, or a tester of the application may further need to test the accuracy and validity of the embedded code. Finally, after the application is re-launched, the embedded code takes effect, and a corresponding event is automatically collected and reported.

Therefore, in the method for annotating an event by using an embedded code, communication and coordination among a plurality of parties are needed, and the communication cost is relatively high. In addition, the embedded code can take in effect only after the application change is launched, and therefore data cannot be obtained instantly for performing analysis.

### SUMMARY

Embodiments of this disclosure provide a method and an apparatus for annotating an event in an application, a device, and a storage medium. Technical solutions include the following:

Some aspects of the disclosure provide a method for annotating in an application. In some examples, a user interface of an event annotating tool is displayed in a browser. In response to a start operation for an application experience simulator, a user interface of the application experience simulator is displayed in the user interface of the event annotating tool. The application experience simulator is a runtime instance of the application to be analyzed via the annotating in the application. When the application experience simulator enters an element selection mode, in response to a selection operation of a first element in the user interface of the application experience simulator, event annotating information related to the first element is displayed in the user interface of the event annotating tool. The event annotating information includes at least an interaction type and/or a display feature of an element related to the first element. In response to a confirmation operation on the event annotating information, one or more operation events that occur in the application corresponding to the application experience simulator and match the event annotating information are annotated.

Some aspects of the disclosure provide an information processing apparatus that includes processing circuitry configured to perform the method for annotating in an application.

Some aspects of the disclosure also provide a non-transitory computer-readable storage medium storing instructions which when executed by at least one processor cause the at least one processor to perform the method for annotating in an application.

According to an aspect of the embodiments of this disclosure, a method for annotating an event in an application is provided. The method includes: displaying a user interface of an event annotating tool in a browser; displaying, in response to a start operation for an application experience simulator, a user interface of the application experience simulator in the user interface of the event annotating tool, the application experience simulator being an application runtime instance for use by an analyst in an interactive manner; after the application experience simulator enters an element selection mode, displaying, in response to a selection operation for a first element in the user interface of the application experience simulator, event annotating information related to the first element in the user interface of the event annotating tool, the event annotating information being configured for annotating an interaction type and a display feature of an element related to the first element; and annotating, in response to a confirmation operation for the event annotating information, an operation event that is in an application corresponding to the application experience simulator and matches the event annotating information.

According to an aspect of the embodiments of this disclosure, an apparatus for annotating an event in an application is provided. The apparatus includes: a tool interface display module, configured to display a user interface of an event annotating tool in a browser; an experience simulator interface display module, configured to display, in response to a start operation for an application experience simulator, a user interface of the application experience simulator in the user interface of the event annotating tool, the application experience simulator being an application runtime instance for use by an analyst in an interactive manner; an annotating information display module, configured to display, after the application experience simulator enters an element selection mode and in response to a selection operation for a first element in the user interface of the application experience simulator, event annotating information related to the first element in the user interface of the event annotating tool, the event annotating information being configured for annotating an interaction type and a display feature of an element related to the first element; and an operation event annotating module, configured to annotate, in response to a confirmation operation for the event annotating information, an operation event that is in an application corresponding to the application experience simulator and matches the event annotating information.

According to an aspect of the embodiments of this disclosure, a computer device is provided, including a processor (an example of processing circuitry) and a memory, the memory having a computer program stored therein, and the computer program being loaded and executed by the processor to implement the foregoing method for annotating an event in an application.

According to an aspect of the embodiments of this disclosure, a computer-readable storage medium is provided, the computer-readable storage medium having a computer program stored therein, and the computer program being loaded and executed by a processor to implement the foregoing method for annotating an event in an application.

According to an aspect of the embodiments of this disclosure, a computer program product is provided, including a computer program, the computer program being stored in a computer-readable storage medium (e.g., a non-transitory computer-readable storage medium), and a processor being configured to read the computer program from the computer-readable storage medium and execute the computer program to implement the foregoing method for annotating an event in an application.

The technical solutions provided in the embodiments of this disclosure have at least the following beneficial effects:

An event in an application is visually annotated by using an event annotating tool. Compared with an embedded code, the difficulty of event annotating is reduced, so that an analyst can independently complete event annotating by using the event annotating tool and does not need to perform multi-party communication and coordination with a developer, a tester, or the like, so that the communication cost is reduced and the event annotating efficiency is improved.

### BRIEF DESCRIPTION OF THE DRAWINGS

FIG. 1 is a schematic diagram of a system for annotating an event according to an embodiment of this disclosure.

FIG. 2 is a flowchart of a method for annotating an event in an application according to an embodiment of this disclosure.

FIG. 3 is a schematic diagram of starting an application experience simulator according to an embodiment of this disclosure.

FIG. 4 is a schematic diagram of entering or exiting from an element selection mode according to an embodiment of this disclosure.

FIG. 5 is a schematic diagram of displaying event annotating information according to an embodiment of this disclosure.

FIG. 6 is a flowchart of a method for annotating an event in an application according to another embodiment of this disclosure.

FIG. 7 is block diagram of an apparatus for annotating an event in an application according to an embodiment of this disclosure.

FIG. 8 is a block diagram of an apparatus for annotating an event in an application according to an embodiment of this disclosure.

FIG. 9 is a schematic diagram of a structure of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Referring to FIG. 1, FIG. 1 is a schematic diagram of a system for annotating an event according to an embodiment of this disclosure. The system for annotating an event is configured to annotate and extract an event in an application, to instantly obtain data to perform object behavior analysis of the application. As shown in FIG. 1, the system for annotating an event includes: an application 10, an event annotating tool 20, and an application experience simulator 30 (also referred to as an application experience device 30 in some examples).

In this embodiment of this application, an analyst annotates, by using the event annotating tool 20, an event to be extracted from the application 10. As shown in FIG. 1, the event annotating tool 20 runs based on a browser. After a related parameter (for example, a scenario parameter or a path parameter), of the application, entered by an analyst is received, the event annotating tool 20 loads and runs, by using the browser, an online code package of the application 10 based on the related parameter, to obtain an application experience simulator 30. In addition, a user interface of the application experience simulator 30 is displayed in a user interface of the event annotating tool 20.

After the application experience simulator 30 enters the element selection mode, in response to a selection operation by the analyst for any element in the user interface of the application experience simulator 30, the event annotating tool 20 displays, in the user interface, event annotating information related to the element. Then, in response to a confirmation operation by the analyst on the event annotating information, the event annotating tool 20 annotates operation events in the application 10 and matching the event annotating information. These operation events are also to be extracted and stored, for the analyst to perform analysis on an object behavior of the application 10.

In some embodiments, the application 10 is a child application that relies on a target application to be run. The child application may be referred to as a mini program. Although the mini program cannot be run independently, the mini program can be used without being downloaded and installed. For example, the child application can be directly opened by scanning a two-dimensional code corresponding to the child application or searching for a name of the child application. In this implementation, the application 10 serves as a child application, and the target application is a parent application of the child application. The parent application provides an environment for implementation of the child application, and the child application may be conveniently obtained and propagated in the parent application. The parent application is a native application. A native application is an application that can be directly run in an operating system. For example, the parent application may be a social application, a dedicated application specially supporting the child application, a file management application, an email application, a game application, or the like. The social application includes, but is not limited to, an instant messaging application, a social network service (SNS), a live broadcast application, or the like.

In addition, as shown in FIG. 1, the event annotating tool 20 and the browser for the event annotating tool 20 to be run thereon are both run on a physical computer device 40. The computer device 40 may be connected to a network to obtain an online code package or the like of the application 10. The network may be a wide area network, a local area network, a metropolitan area network, a personal area network, the Internet, or the like. In some embodiments, the computer device 40 may be implemented as server, or may be implemented as a terminal such as a tablet, a mobile phone, or a personal computer (PC). When being implemented as a server, the computer device 40 may be a single server, or a server cluster including a plurality of servers, or a cloud computing center. This is not limited in the embodiments of this disclosure.

For other introduction and description about the application experience simulator and a starting manner thereof, the element selection mode and an entering and exiting manner thereof, the event annotating information and an obtaining and displaying manner thereof in the embodiments of FIG. 1, refer to the following method embodiments. Details are not described herein again.

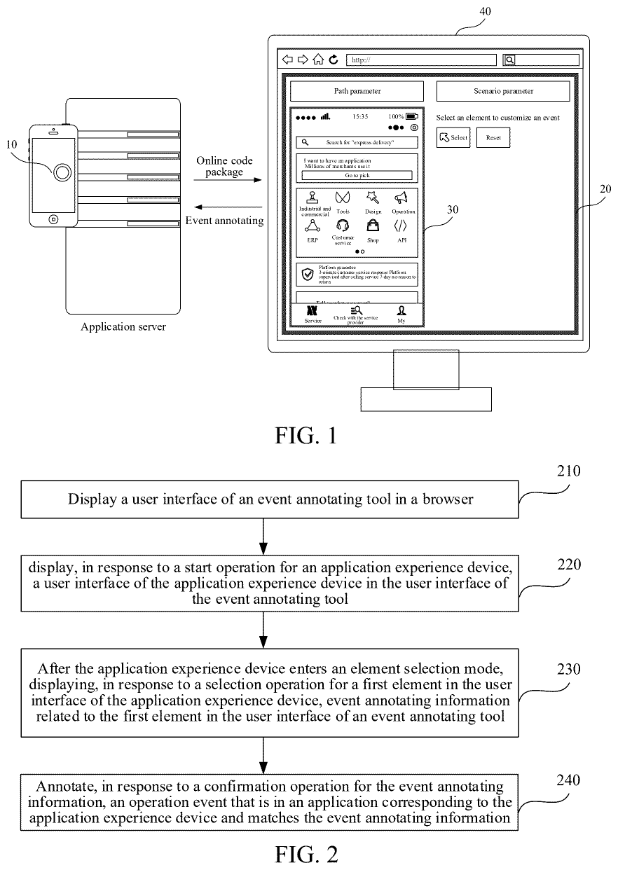

FIG. 2 is a flowchart of a method for annotating an event in an application according to an embodiment of this disclosure. The method may be applied to an event annotating tool, for example, the event annotating tool 20 shown in FIG. 1. The method is performed by a terminal device. As shown in FIG. 2, the method for annotating an event includes at least one of the following operations (operations 210 to 240).

Operation 210: Display a user interface of an event annotating tool in a browser.

In some embodiments, the event annotating tool is run based on a browser, and after the event annotating tool is started, a user interface of the event annotating tool may be displayed in the browser. In some embodiments, a starting manner of the event annotating tool includes, but is not limited to, entering a website in the browser, searching for a name, scanning a two-dimensional code, entering a voice instruction, or the like.

In some embodiments, the event annotating tool may be an independent client installed in a terminal device. For example, the event annotating tool is run in an application (APP) mode. In some embodiments, the event annotating tool may alternatively be a plug-in integrated in another client, or implemented as a functional module in another client. This is not limited in this disclosure.

Display content of an initial user interface after the event annotating tool is started is not limited in the embodiments of this disclosure. In some embodiments, an input interface for identity verification information such as an account name, a login password, and a biological feature is displayed in the initial user interface. In response to corresponding information entered by an analyst, the event annotating tool turns from the initial user interface to a user interface in a routine working state. Alternatively, the initial user interface is directly displayed as a user interface in a routine working state. The user interface in the routine working state includes at least one of the following: a user interface for starting an application experience simulator, a user interface for performing event annotating, or a user interface for setting an event annotating attribute (for example, a name or an event storage location).

Operation 220: Display, in response to a start operation for an application experience simulator, a user interface of the application experience simulator in the user interface of the event annotating tool.

The application experience simulator is an application runtime instance for use by an analyst in an interactive manner. The application experience simulator is obtained by the browser by loading an online code package of the application to be run thereon. After the application experience simulator is started, the user interface of the application experience simulator is directly displayed in the user interface of the event annotating tool. In some embodiments, a display level of the user interface of the application experience simulator is equal to a display level of the user interface of the event annotating tool, and the user interface of the application experience simulator may be displayed in a content blank part of the user interface of the event annotating tool. Alternatively, a display level of the user interface of the application experience simulator is higher than a display level of the user interface of the event annotating tool, and the user interface of the application experience simulator may be displayed above the user interface of the event annotating tool in a form such as a floating window. In some embodiments, the user interface of the application experience simulator may be displayed in a fixed manner or in a flexibly movable manner in the user interface of the event annotating tool. When the user interface of the application experience simulator may be flexibly moved, displaying locations of elements in the user interface of the event annotating tool may be adaptively moved to avoid being blocked, or when the user interface of the application experience simulator is displayed in a form such as a floating window, the user interface of the event annotating tool may remain unchanged.

The starting manner of the application experience simulator is not limited in the embodiments of this disclosure. In some embodiments, the application experience simulator may be started in a manner such as entering a website, searching for a name, scanning a two-dimensional code, entering a voice instruction, or entering identity verification information. The following exemplarily shows several starting manners of the application experience simulator.

In an example, the start operation for the application experience simulator includes receiving, by the user interface of the event annotating tool, a scenario parameter. Based on the above, operation 220 includes: loading, based on a scenario parameter received in the user interface of the event annotating tool, an online code package of the application in a delivery channel corresponding to the scenario parameter; running the online code package to obtain the application experience simulator; and displaying the user interface of the application experience simulator in the user interface of the event annotating tool.

In another example, the start operation for the application experience simulator includes receiving, by the user interface of the event annotating tool, a path parameter. Based on the above, operation 220 includes: loading the online code package of the application; running the online code package to obtain the application experience simulator; and displaying, based on a path parameter received in the user interface of the event annotating tool, the user interface of the application experience simulator in the user interface of the event annotating tool, an initial user interface of the application experience simulator matching the path parameter.

The scenario parameter is configured for positioning a source channel of the online code package, that is, a delivery channel of the application corresponding to the application experience simulator, for example, an obtaining source of the application or a parent application providing an environment for running of the application. The path parameter is configured for positioning an initial user interface, such as a home page, a setting page, a login page, or a personal information page, of the application experience simulator. In an actual application, the application experience simulator may alternatively be started by combining the scenario parameter and the path parameter. In some embodiments, the user interface of the event annotating tool may further display an experience simulator start control. If the analyst does not enter a scenario parameter and/or a path parameter, and instead operates the experience simulator start control, the event annotating tool starts the application experience simulator according to a default scenario parameter and/or a default path parameter in response to the operation for the experience simulator start control.

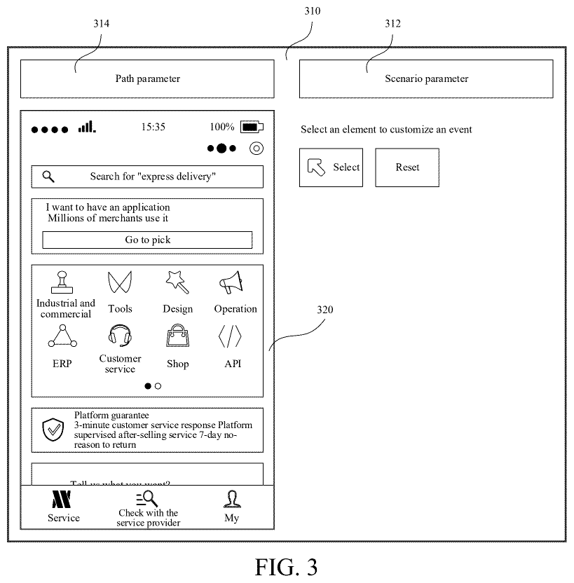

For example, as shown in FIG. 3, a user interface 310 of the event annotating tool displays an input interface 312 for a scenario parameter and an input interface 314 for a path parameter. After an analyst enters corresponding parameters in the input interface 312 and the input interface 314, the event annotating tool receives the scenario parameter and the path parameter. First, in response to the scenario parameter, an online code package of an application in a delivery channel corresponding to the scenario parameter is loaded. Subsequently, the online code package is run to obtain an application experience simulator. Then, a user interface 320 of the application experience simulator is displayed in the user interface 310 of the event annotating tool in response to the path parameter. An initial user interface of the application experience simulator matches the path parameter.

In still another example, the start operation for the application experience simulator includes reviving, by the user interface of the event annotating tool, identity verification information. Based on the above, operation 220 includes: obtaining, in response to the identity verification information received in the user interface of the event annotating tool, historical program parameters corresponding to the identity verification information, the historical program parameters including a historical scenario parameter and a historical path parameter; loading an online code package of the application in a delivery channel corresponding to the historical scenario parameter; running the online code package to obtain the application experience simulator; and displaying the user interface of the application experience simulator in the user interface of the event annotating tool, an initial user interface of the application experience simulator matching the historical path parameter. In some embodiments, the identity verification information includes, but is not limited to, an account name, a login password, a biological feature, or the like.

The historical program parameters may be a scenario parameter and a path parameter entered by the analyst when previously performing event annotating by using the event annotating tool, or a scenario parameter corresponding to a source channel of the loaded online code package and a path parameter corresponding to a source channel of the annotated event. Certainly, the historical program parameters may alternatively be a scenario parameter and a path parameter that have highest input frequencies when the analyst performs event annotating by using the event annotating tool for the first N (N is an integer greater than 2) times, or a scenario parameter corresponding to a source channel of an online code package having a highest loading frequency and a path parameter corresponding to a source channel having a largest number of annotated events. This is not limited in the embodiments of this disclosure.

The event annotating tool may record and store mapping relationships between the identity verification information and the historical program parameters. Each time after the analyst enters identity verification information and a program parameter, or each time after the analyst completes event annotating, the event annotating tool updates the mapping relationships, and replaces some or all of the stored historical program parameters with current program parameters. In some embodiments, the user interface of the event annotating tool may display a parameter update control. After completing the event annotating, the analyst may freely select, by using the parameter update control, whether to replace a historical program parameter with a current program parameter, so as to implement updating of the foregoing mapping relationships.

Operation 230: After the application experience simulator enters an element selection mode, display, in response to a selection operation for a first element in the user interface of the application experience simulator, event annotating information related to the first element in the user interface of an event annotating tool.

In some embodiments, the event annotating information is configured for annotating an interaction type and a display feature of an element related to the first element.

The element selection mode refers to a functional mode provided by the event annotating tool and performing an operation in the user interface of the application experience simulator. In the mode, the application experience simulator skips responding to an interaction operation received in the user interface of the application experience simulator, and instead, the event annotating tool responds to the interaction operation.

After the application experience simulator is started, the analyst may use the application experience simulator in an interactive manner like a user of the application. For each interaction operation of the analyst, the application experience simulator gives a corresponding feedback according to running logic of the application. Moreover, when the application experience simulator is in the element selection mode, the application experience simulator skips responding to the interaction operation received in the user interface of the application experience simulator, and instead, the event annotating tool responds to the interaction operation, to avoid an impact on the analysis process caused by a response of the user interface of the application experience simulator. After the element selection mode is exited, the event annotating tool clears the current selection element and the current event annotating information, to avoid an impact on a subsequent operation caused by the event annotating information.

When the application experience simulator is in the element selection mode, the interaction operation by the analyst for the user interface of the application experience simulator includes a selection operation for any element in the user interface of the application experience simulator. The element is a visible element in the user interface. A type of the element includes, but is not limited to, a text, a picture, a button, a symbol, an icon, a slider, a video, a progress bar, an audio, a label, or the like. In this case, the event annotating tool responds to the selection operation, and displays, in the user interface of the event annotating tool, the event annotating information related to the element. For specific content, obtaining manner, display manner, and the like of the event annotating information, refer to the following method embodiments.

Manners of entering and exiting the element selection mode are not limited in the embodiments of this disclosure. In some embodiments, the element selection mode may be entered and exited in a manner such as an operation for a specific control, entering a voice instruction, or entering a gesture. In an example, the element selection mode is entered and exited by using an operation for a specific control. After foregoing operation 220, the method further includes: controlling, in response to an operation for a mode selection control on a user interface of the event annotating tool, the application experience simulator to enter the element selection mode. After the controlling the application experience simulator to enter the element selection mode, the method further includes: clearing, in response to an operation for an element reset control in the user interface of the event annotating tool, a current selection element and current event annotating information in the event annotating tool, and controlling the application experience simulator to exit the element selection mode. The mode selection control and the element reset control may be displayed in a form of buttons, icons, slide blocks, or the like. Operations on the mode selection control and the element reset control include, but are not limited to, a click/tap operation, a double click/tap operation, a press operation, a slide operation, or the like.

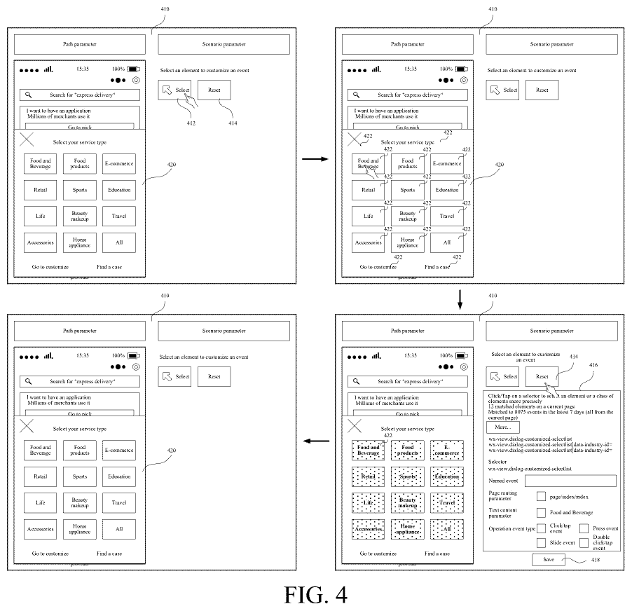

For example, as shown in FIG. 4, a user interface 410 of the event annotating tool displays a mode selection control 412 and an element reset control 414. After the analyst clicks/taps on the mode selection control 412, the application experience simulator enters the element selection mode, and no longer responds to an interaction operation for the user interface 420 of the application experience simulator. When the application experience simulator is in the element selection mode, the analyst clicks/taps on any element 422 in the user interface 420 of the application experience simulator, and the event annotating tool displays, in response to the operation by the analyst, event annotating information 416 related to the element 422 in the user interface 410 of the event annotating tool. After clicking/tapping on the element reset control 414, the analyst clears the current selection element 422 and the current event annotating information 416 in the event annotating tool, and the application experience simulator also exits the element selection mode and resumes responding to an interaction operation by the analyst on the user interface 420 of the application experience simulator.

In some embodiments, the mode selection control may not be displayed in the user interface of the event annotating tool. For example, in response to the first operation for the user interface of the event annotating tool, the application experience simulator is controlled to enter the element selection mode. The first operation may be preset during development of the event annotating tool, or may be customized by a user of the event annotating tool. This is not limited in this application. The first operation includes, but is not limited to, a click/tap operation, a double click/tap operation, a press operation, a slide operation, or the like.

Operation 240: Annotate, in response to a confirmation operation for the event annotating information, an operation event that is in an application corresponding to the application experience simulator and matches the event annotating information.

The analyst may modify the event annotating information. Refer to the following method embodiments for a modification manner of the event annotating information. If the analyst does not have a modification requirement or has completed modification, event annotating may be completed by confirming the event annotating information. A manner of confirming the event annotating information is not limited in this embodiments of this disclosure. In some embodiments, the event annotating information may be confirmed in a manner such as an operation for a specific control, entering a voice instruction, or entering a gesture. For example, as shown in FIG. 4, the user interface 410 of the event annotating tool displays an information confirmation control 418. The analyst can implement confirmation of the event annotating information by clicking/tapping on the information confirmation control 418.

In response to the confirmation operation by the analyst on the event annotating information, the event annotating tool annotates all operation events that are in the application corresponding to the application experience simulator and match the event annotating information. In the embodiments of this disclosure, an event type of the operation event annotated by the event annotating tool in operation 240 may be consistent with or may be inconsistent with a type of the selection operation performed by the analyst in operation 230. For example, if the selection operation performed by the analyst is a click/tap operation, the operation event annotated by the event annotating tool may include only a click/tap event, or may include a click/tap event, a press event, a slide event, a double click/tap event, or the like.

In the embodiments of this disclosure, all operation events of a (application) user for the application are acquired and stored in real time, for example, stored in a server of the application. When performing event annotating, the event annotating tool may extract an operation event matching the event annotating information from a storage location of the operation events, export the operation event or store the operation event at a default storage location or a storage location specified by the analyst, so that the analyst can instantly obtain related data and instantly perform object behavior analysis of the application.

In conclusion, in the embodiment of this disclosure, an application experience simulator corresponding to an application is started by using an event annotating tool; when the application experience simulator is in an element selection mode, in response to a selection operation by an analyst on any element in a user interface of the application experience simulator, event annotating information related to the element is obtained and displayed; and then, in response to a confirmation operation by the analyst on the event annotating information, all operation events that are in the application and match the event annotating information are annotated. In the embodiments of this disclosure, an event in an application is visually annotated by using an event annotating tool. Compared with an embedded code, the difficulty of event annotating is reduced, so that an analyst can independently complete event annotating by using the event annotating tool and does not need to perform multi-party communication and coordination with a developer, a tester, or the like, so that the communication cost is reduced and the event annotating efficiency is improved. In addition, all operation events of the user of the application for the application are acquired and stored in real time, so that when performing event annotating, the event annotating tool can immediately extract and store a corresponding operation event, and the analyst can instantly obtain related data and perform analysis without launching an application change, so that the object behavior analysis efficiency of the application is improved.

In addition, the embodiments of this disclosure provide a plurality of manners for flexibly starting the application experience simulator. The application experience simulator is started by using a scenario parameter, so that a delivery channel of the application may be selected, and an object behavior of the application in the corresponding delivery channel may be analyzed in a targeted manner; the application experience simulator is started by using a path parameter, so that an initial user interface displayed after the application experience simulator is started may be selected, so as to directly position to a source page of an event to be annotated by the analyst; the application experience simulator is started by using a historical program parameter corresponding to the identity verification information, so that an annotating habit of the analyst can be matched, and the analyst can rapidly perform event annotating.

Manners for obtaining, displaying, and modifying the event annotating information are introduced and described below.

In an example, operation 230 includes the following sub-operations (operations

232 to 234).

Operation 232: Obtain a first element set from the user interface of the application experience simulator in response to a selection operation for the first element.

The first element set includes the first element and a similar element of the first element. In some embodiments, the similar element of the first element has at least one of the following features: having an interaction type the same as that of the first element, having a display feature the same as or partially the same as that of the first element, having text content the same as that of the first element, and being located in a display area the same as that of the first element. For example, the similar element of the first element has an interaction type (that is, a tag label) the same as that of the first element, and has at least one same display feature (that is, a class label).

In some embodiments, in the embodiments of this disclosure, the similar element is obtained by using a document object model (DOM) tree. Based on the above, operation 232 includes: obtaining a DOM tree corresponding to the user interface of the application experience simulator; and searching for the similar element of the first element based on the DOM tree, and constructing the first element set based on a search result. The DOM tree is configured for indicating elements in the user interface of the application experience simulator and a hierarchical relationship among the elements; and each node in the DOM tree corresponds to an element in the user interface of the application experience simulator, and each node includes information such as an identifier, a level, an instance, and a child node of the corresponding element. When the similar element is obtained by using the DOM tree, the event annotating tool may reduce a search range based on heuristic searching, to improve the search efficiency.

Based on the above, in some embodiments, the searching for the similar element of the first element based on the DOM tree, and constructing the first element set based on a search result includes: obtaining sibling elements of the first element; searching for the similar element of the first element sibling elements of the first element; combining the first element and the similar element of the first element, to obtain the first element set if the sibling elements of the first element include the similar element of the first element; performing recursive upward searching in the DOM tree if the sibling elements of the first element do not include the similar element of the first element; and constructing the first element set by using the first element if the recursive upward searching reaches a recursive level threshold and no similar elements of the first element are found.

Nodes corresponding to the sibling elements of the first element and a node corresponding to the first element are located at a same level in the DOM tree. By searching for the similar element from the sibling elements of the first element, the search range is effectively reduced. The interaction type includes, but is not limited to, clicking/tapping, pressing, sliding, or the like, and the display feature includes, but is not limited to, a display color, a display shape, a display location, a display element, or the like.

If the sibling elements of the first element do not include the similar element of the first element, the event annotating tool performs recursive upward searching in the DOM tree. The recursive upward searching indicates replacing the first element with a parent element of the first element, and again continuing the process starting from obtaining sibling elements of the first element, that is, again searching for the similar element by using the parent element of the first element. By performing the recursive upward searching, a case in which elements in a list rendering manner are nested may be considered, so that the accuracy of searching for the similar element is improved. However, in consideration of a quantity of layers rendered in the list and the efficiency of searching for the similar element, in this example, a recursive level threshold, for example, two or three layers, is set for the recursive upward searching. If the recursive upward searching does not reach the recursive level threshold and the similar element of the first element is found, the first element set is constructed by using the first element and the similar element. If the recursive upward searching reaches the recursive level threshold and no similar elements of the first element are found, the event annotating tool cancels searching for the similar element of the first element, and directly constructs the first element set by using the first element. In some embodiments, the recursive level threshold may be set by an analyst (the user of the event annotating tool), or may be set by a developer of the event annotating tool. This is not limited in this disclosure.

Operation 234: Display, in the user interface of the event annotating tool, selectors for elements in the first element set and parent elements thereof.

In some embodiments, the parent element of the first element is an upper-level element of the first element, or the parent element of the first element and the first element are in an inclusion relationship. It is embodied in this embodiment of this disclosure that a level of the parent element of the first element in the DOM tree is higher than a level of the first element in the DOM tree. For example, the parent element of the first element is a text paragraph element in the user interface of the application experience simulator, and the first element is one or more text elements in the text paragraph.

The event annotating information includes a selector for at least one element, and the selector is configured for annotating an interaction type and a display feature of the element. After obtaining the event annotating information, the event annotating tool may display the event annotating information on the user interface of the event annotating tool, for an analyst to modify and confirm. In some embodiments, to reduce the difficulty in understanding the event annotating information and give a positive feedback to an analyst, when displaying the event annotating information, the event annotating tool may further perform enhanced displaying on the elements in the first element set and the parent elements thereof in the user interface of the application experience simulator. In some embodiments, the manner of the enhanced displaying includes, but is not limited to, highlighting of a text and a picture, bold displaying of a text and a line, additional displaying of a text and an icon, or the like.

When there is a modification requirement, the analyst can implement precise selection of an event source element by operating the selectors. Based on this, after the event annotating tool displays the event annotating information, in response to a removal operation for a selector of a second element in the user interface of the event annotating tool, enhanced displaying of the second element is canceled in the user interface of the application experience simulator. The second element indicates any element among the elements in the first element set and the parent elements thereof. The removal operation for the selector of the second element includes, but is not limited to, a click/tap operation, a slide operation, a press operation, or the like. When the analyst removes the selector of the second element, in addition to canceling the enhanced displaying of the second element in the user interface of the application experience simulator, a display style of the selector of the second element may further be changed in the user interface of the event annotating tool, to remind the analyst whether to select the second element. In some embodiments, a change of the display style includes, but is not limited to, at least one of the following: a display color change, an icon state change, display content change, or the like.

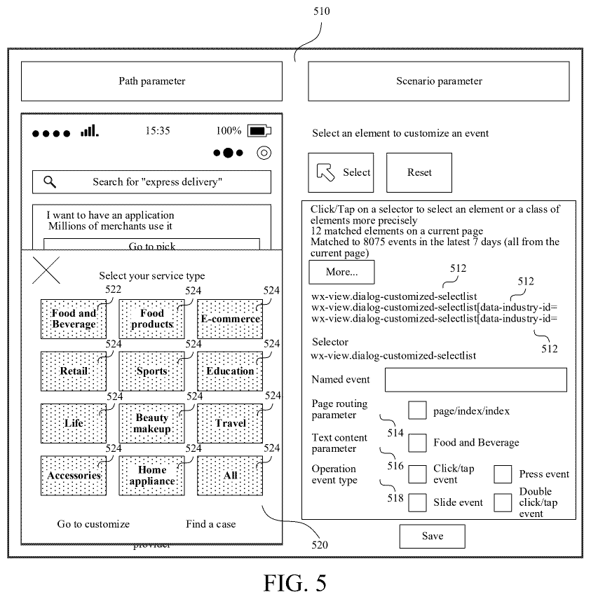

For example, as shown in FIG. 5, assuming that an analyst clicks/claps on an element 522 in a user interface 520 of an application experience simulator, the event annotating tool automatically infers a similar element of the element 522 to construct a first element set, and displays event annotating information in the user interface 510 of the event annotating tool. The event annotating information includes selectors 512 for elements in the first element set and parent elements thereof. In addition, in the user interface 520 of the application experience simulator, the element 522 and a similar element 524 thereof are enhanced displayed by using a bold text, and parent elements of these elements are enhanced displayed by regional highlighting.

In an example, to meet a requirement of an analyst for richer and more precise event annotating, after operation 232, the method further includes: displaying at least one supplementary annotating condition in the user interface of the event annotating tool. In response to a selection operation for a first supplementary annotating condition of the at least one supplementary annotating condition, the event annotating information further includes the first supplementary annotating condition.

In some embodiments, the supplementary annotating condition includes at least one of the following: a page routing parameter, element text content, and an operation event type. The page routing parameter is configured for restricting (limiting) that an operation event is sourced from a current user interface of the application experience simulator. The element text content is configured for restricting (limiting) that the operation event is for specific text content. The operation event type is configured for restricting (limiting) that the operation event is for specific event type. In some embodiments, the event type includes, but is not limited to, a click/tap event, a press event, a double click/tap event, a slide event, or the like. In a case that an analyst specifies an operation event type, an event type of an operation event annotated and extracted by the event annotating tool may be inconsistent with a selection operation by the analyst on an event source element. For example, if the analyst selects the event source element by means of a click/tap operation, but subsequently additionally selects two supplementary annotating conditions, i.e., a slide event and a press event, things that are annotated and extracted by the event annotating tool are a slide event and a press event for the event source element and a related element.

For example, as shown in FIG. 5, the user interface 510 of the event annotating tool further displays three types of supplementary annotating conditions, respectively, a page routing parameter 514, element text content 516, and an operation event type 518. By clicking/tapping on content or a control corresponding to the page routing parameter 514, the analyst may add, to the event annotating information, a parameter for restricting that the operation event is sourced from a current user interface of the application experience simulator. By clicking/tapping on content or a control corresponding to the element text content 516, the analyst may add, to the event annotating information, a parameter for restricting that the operation event is for specified text content. By clicking/tapping on content or a control corresponding to the operation event type 518, the analyst may add, to the event annotating information, a parameter for restricting that the operation event is for a specified event type.

In conclusion, in the embodiments of this disclosure, after an analyst selects an event source element in the user interface of the application experience simulator, the event annotating tool automatically infers a similar element of the event source element and obtains and displays event annotating information based on the event source element and the similar element, so that quick annotating of events corresponding to a type of elements is implemented. In addition, when the event annotating tool infers a similar element, considering that a list rendering manner may exist for rendering of a user interface. When necessary, a similar element is searched recursively upward from a parent element of an event source element, so that the accuracy and comprehensiveness of searching for the similar element are improved. In addition, in the embodiments of this disclosure, event annotating information is additionally restricted by using a page routing parameter, element text content, an operation event type, or the like, so that the requirement of an analyst for richer and more precise event annotating is met.

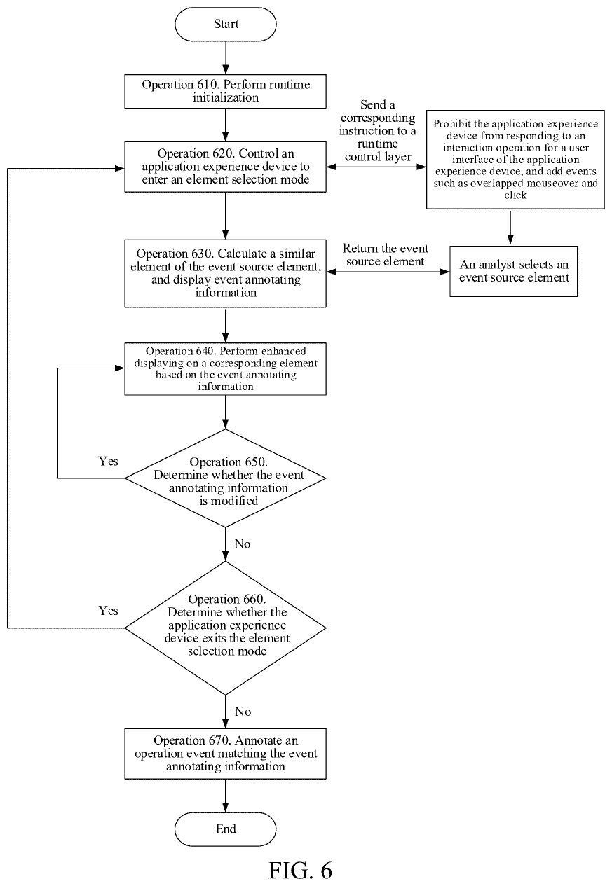

The overall process of the method for annotating an event provided in this application is described below by using an embodiment. The method may be applied to an event annotating tool, for example, the event annotating tool 20 shown in FIG. 1. In an example, the event annotating tool includes a runtime control layer, an event annotating editor, and an event definition manager. As shown in FIG. 6, the method for annotating an event includes at least one of the following operations (operations 610 to 670).

Operation 610: Perform runtime initialization.

The runtime control layer performs runtime initialization. The runtime

initialization includes: loading an online code package of an application, running the online code package, and displaying a user interface of an application experience simulator. After the online code package of the application is loaded, an event annotating tool may automatically inject a customized script, so as to package addEventListener by one layer, to implement interception and recording of an operation event. In addition, interaction operations performed in the user interface of the application experience simulator by using pauseInnerCaptureMouseListeners and resumeInnerCaptureMouseListeners for a dynamic close response and a dynamic restore response are respectively implemented. In addition, proper running of the application experience simulator is ensured by registering and closing life cycle hooks such as an application experience simulator and a route change. Methods such as entering an element selection mode, exiting an element selection mode, and enhanced displaying are packaged, and customized logic is added by injecting a script to a corresponding level (native, webview) in an application experience simulator iframe (inline frame).

Operation 620: Control an application experience simulator to enter an element selection mode.

In response to a corresponding operation by an analyst, an event definition manager sends a corresponding instruction to a runtime control layer, controls the application experience simulator to enter an element selection mode, prohibits the application experience simulator from responding to an interaction operation for a user interface of the application experience simulator, and may add events such as overlapped mouseover and click.

Operation 630: Calculate a similar element of an event source element, and display event annotating information.

In response to a selection operation by the analyst on the event source element, the event definition manager returns the event source element to the event annotating editor. The event annotating editor further infers the similar element of the event source element, determines a selector for at least one element in the event annotating information based on the event source element and the similar element, and initializes and displays the event annotating information.

Operation 640: Perform enhanced displaying on a corresponding element based on the event annotating information.

The event definition manager coordinates, based on a selector in the event annotating information and a selection operation by the analyst on a supplementary annotating condition in the event annotating information set by the event annotating editor, a corresponding enhanced displayed element of the runtime control layer in the user interface of the application experience simulator.

Operation 650: Determine whether the event annotating information is modified.

In response to a corresponding operation of the analyst, the event definition manager determines whether the event annotating information is modified. If the event annotating information is modified, operation 640 is performed again by using the modified event annotating information, that is, the event annotating editor needs to respond to the element change. If the event annotating information is not modified, operation 660 is continuously performed.

Operation 660: Determine whether the application experience simulator exits the element selection mode.

In response to the corresponding operation by the analyst, the event definition manager determines whether the application experience simulator exits the element selection mode, that is, whether the event annotating information is reset. If the application experience simulator equipment exits the element selection mode, after the analyst performs another operation to enable the element selection mode, the process is performed again starting from operation 620. If the application experience simulator does not exit the element selection mode, following operation 670 is continuously performed.

Operation 670: Annotate an operation event matching the event annotating information.

In response to a confirmation operation by the analyst on the event annotating information, the event definition manager annotates all operation events that are in the application and match the event annotating information, and stores these operation events for the analyst to perform object behavior analysis or the like.

For other introduction and description about manners for entering and exiting an element selection mode, a manner for calculating a similar element, a manner for starting an application experience simulator, specific content of the event annotating information, an element enhanced displaying manner, or the like in the embodiments of FIG. 6, refer to the foregoing method embodiments. Details are not described herein again.

The following describes apparatus embodiments of this disclosure, which can be configured for executing the method embodiments of this disclosure. For details not disclosed in the apparatus embodiments of this disclosure, refer to the method embodiments of this disclosure.

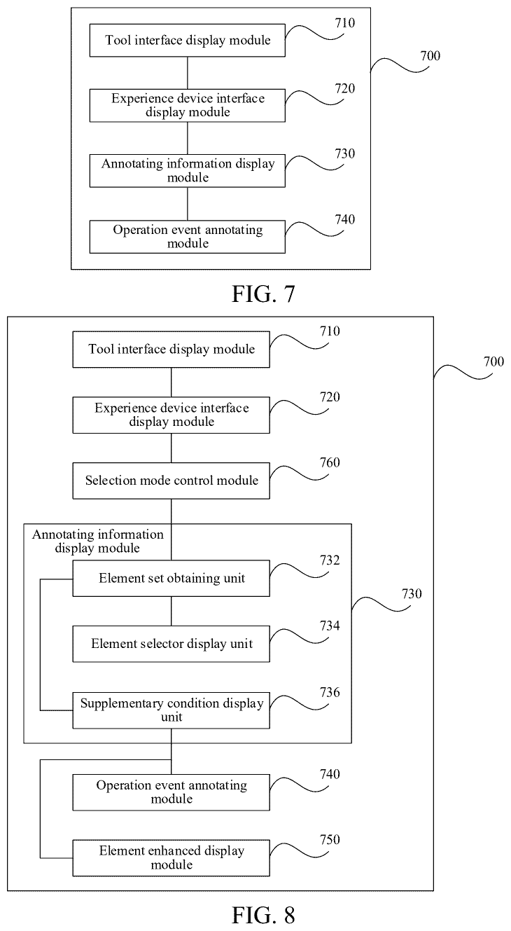

FIG. 7 is block diagram of an apparatus for annotating an event in an application according to an embodiment of this disclosure. The apparatus has a function of implementing the foregoing method for annotating an event in an application, and the function may be implemented by hardware or by hardware executing corresponding software. The apparatus may be a computer device, or may be disposed on a computer device. The apparatus 700 may include: a tool interface display module 710, an experience simulator interface display module 720, an annotating information display module 730, and an operation event annotating module 740.

The tool interface display module 710 is configured to display a user interface of an event annotating tool in a browser.

The experience simulator interface display module 720 is configured to display, in response to a start operation for an application experience simulator, a user interface of the application experience simulator in the user interface of the event annotating tool, the application experience simulator being an application runtime instance for use by an analyst in an interactive manner.

The annotating information display module 730 is configured to display, after the application experience simulator enters an element selection mode and in response to a selection operation for a first element in the user interface of the application experience simulator, event annotating information related to the first element in the user interface of the event annotating tool, the event annotating information being configured for annotating an interaction type and a display feature of an element related to the first element.

The operation event annotating module 740 is configured to annotate, in response to a confirmation operation for the event annotating information, an operation event that is in an application corresponding to the application experience simulator and matches the event annotating information.

In an example, as shown in FIG. 8, the annotating information display module 730 includes: an element set obtaining unit 732, configured to obtain a first element set from the user interface of the application experience simulator in response to a selection operation for the first element, the first element set including the first element and a similar element of the first element; and an element selector display unit 734, configured to display, in the user interface of the event annotating tool, selectors for elements in the first element set and parent elements thereof. The event annotating information includes a selector for at least one element, the selector is configured for annotating an interaction type and a display feature of the element, and the parent element of the first element is an upper-level element of the first element.

In some embodiments, as shown in FIG. 8, the element set obtaining unit 732 is configured to: obtain a DOM tree corresponding to the user interface of the application experience simulator, the DOM tree being configured for indicating elements in the user interface of the application experience simulator and a hierarchical relationship among the elements; and search for the similar element of the first element based on the DOM tree, and construct the first element set based on a search result.

In some embodiments, as shown in FIG. 8, the element set obtaining unit 732 is further configured to: obtain sibling elements of the first element, nodes corresponding to the sibling elements of the first element and a node corresponding to the first element being located at a same level in the DOM tree; search for the similar element of the first element from the sibling elements of the first element; combine the first element and the similar element of the first element, to obtain the first element set if the sibling elements of the first element include the similar element of the first element; perform recursive upward searching in the DOM tree if the sibling elements of the first element do not include the similar element of the first element, where the recursive upward searching indicates replacing the first element with a parent element of the first element, and again continuing the process starting from obtaining sibling elements of the first element; construct the first element set by using the first element if the recursive upward searching reaches a recursive level threshold and no similar elements of the first element are found, where the similar element of the first element has at least one of the following features: having an interaction type the same as that of the first element, having a display feature the same as or partially the same as that of the first element, having text content the same as that of the first element, and being located in a display area the same as that of the first element.

In an example, as shown in FIG. 8, the apparatus 700 further includes an element enhanced display module 750, configured to: perform enhanced displaying on the elements in the first element set and the parent elements thereof in the user interface of the application experience simulator; and cancel, in response to a removal operation for a selector of a second element in the user interface of the event annotating tool, the enhanced displaying of the second element in the user interface of the application experience simulator. The second element indicates any element among the elements in the first element set and the parent elements thereof.

In an example, as shown in FIG. 8, the annotating information display module 730 further includes a supplementary condition display unit 736, configured to: display at least one supplementary annotating condition in the user interface of the event annotating tool, the supplementary annotating condition including a page routing parameter and element text content, the page routing parameter being configured for restricting that an operation event is sourced from a current user interface of the application experience simulator, and the element text content being configured for restricting that the operation event is for specific text content. In response to a selection operation for a first supplementary annotating condition of the at least one supplementary annotating condition, the event annotating information further includes the first supplementary annotating condition.

In some embodiments, as shown in FIG. 8, the apparatus 700 further includes a selection mode control module 760, configured to: control, in response to an operation for a mode selection control on a user interface of the event annotating tool, the application experience simulator to enter the element selection mode. When the application experience simulator is in the element selection mode, the application experience simulator skips responding to an interaction operation received in the user interface of the application experience simulator.

In some embodiments, as shown in FIG. 8, the selection mode control module 760 is further configured to: clear, in response to an operation for an element reset control in the user interface of the event annotating tool, a current selection element and current event annotating information in the event annotating tool; and control the application experience simulator to exit the element selection mode.

In an example, the experience simulator interface display module 720 is configured to: load, based on a scenario parameter received in the user interface of the event annotating tool, an online code package of the application in a delivery channel corresponding to the scenario parameter; run the online code package to obtain the application experience simulator; and display the user interface of the application experience simulator in the user interface of the event annotating tool. The start operation for the application experience simulator includes receiving, by the user interface of the event annotating tool, the scenario parameter.

In an example, the experience simulator interface display module 720 is configured to: load the online code package of the application; run the online code package to obtain the application experience simulator; and display, based on a path parameter received in the user interface of the event annotating tool, the user interface of the application experience simulator in the user interface of the event annotating tool, an initial user interface of the application experience simulator matching the path parameter. The start operation for the application experience simulator includes receiving, by the user interface of the event annotating tool, the path parameter.

In conclusion, in the embodiment of this disclosure, an application experience simulator corresponding to an application is started by using an event annotating tool; when the application experience simulator is in an element selection mode, in response to a selection operation by an analyst on any element in a user interface of the application experience simulator, event annotating information related to the element is obtained and displayed; and then, in response to a confirmation operation by the analyst on the event annotating information, all operation events that are in the application and match the event annotating information are annotated. In the embodiments of this disclosure, an event in an application is visually annotated by using an event annotating tool. Compared with an embedded code, the difficulty of event annotating is reduced, so that an analyst can independently complete event annotating by using the event annotating tool and does not need to perform multi-party communication and coordination with a developer, a tester, or the like, so that the communication cost is reduced and the event annotating efficiency is improved. In addition, all operation events of the user of the application for the application are acquired and stored in real time, so that when performing event annotating, the event annotating tool can immediately extract and store a corresponding operation event, and the analyst can instantly obtain related data and perform analysis without launching an application change, so that the object behavior analysis efficiency of the application is improved.

When the apparatus provided in the foregoing embodiments implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. In addition, the information storage apparatus provided in the foregoing embodiment belongs to the same conception as the embodiment of the information storage method. For a specific implementation process thereof, refer to the method embodiment. Details are not described herein again.

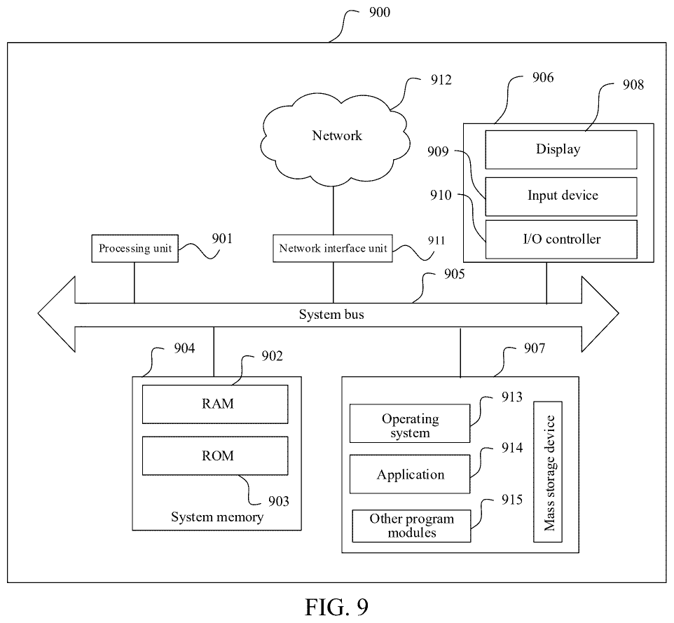

FIG. 9 is a schematic diagram of a structure of a computer device according to an embodiment of this disclosure. The computer device may be configured to implement the functions of the examples of the foregoing method for annotating an event in an application. Details are as follows:

The computer device 900 includes a central processing unit (for example, Central Processing Unit (CPU), Graphics Processing Unit (GPU), and Field Programmable Gate Array (FPGA)) 901, a system memory 904 including a random access memory (RAM) 902 and a read only memory (ROM) 903, and a system bus 905 connecting the system memory 904 and the central processing unit 901. The computer device 900 further includes an input/output system (I/O system) 906 assisting in transmitting information between components in a computer device, and a mass storage device 907 configured to store an operating system 913, an application 914, and another program module 915.

The basic I/O system 906 includes a display 908 configured to display information and an input device 909, such as a mouse or a keyboard, configured to input information for a user. The display 908 and the input device 909 are both connected to the CPU 901 by using an input/output controller 910 connected to the system bus 905. The basic I/O system 906 may further include the input/output controller 910 to be configured to receive and process inputs from a plurality of other devices such as a keyboard, a mouse, and an electronic stylus. Similarly, the input/output controller 910 further provides an output to a display screen, a printer, or another type of output device.

The mass storage device 907 is connected to the CPU 901 by using a mass storage controller (not shown) connected to the system bus 905. The mass storage device 907 and a computer-readable medium associated with the large-capacity storage device provide non-volatile storage to the computer device 900. That is, the mass storage device 907 may include a computer-readable medium (not shown) such as a hard disc or a compact disc read-only memory (CD-ROM).

Generally, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a RAM, a ROM, an erasable programmable read only memory (EPROM), an electrically erasable programmable read only memory (EEPROM), a flash memory or another solid state memory, a CD-ROM, a digital video disc (DVD) or another optical memory, a tape cartridge, a magnetic tape, a magnetic disk memory, or another magnetic storage device. It is noted that that the computer storage medium is not limited to the foregoing several types. The system memory 904 and the mass storage device 907 may be collectively referred to as a memory.

According to the embodiments of this disclosure, the computer device 900 may further be connected, through a network such as the Internet, to a remote computer on the network for running. That is, the computer device 900 may be connected to a network 912 by using a network interface unit 911 connected to the system bus 905, or may be connected to another type of network or a remote computer system (not shown) by using a network interface unit 911.

The memory further includes a computer program. The computer program is stored in the memory and configured to be executed by one or more processors to implement the foregoing method for annotating an event in an application.

In some embodiments, a computer-readable storage medium is further provided, the storage medium having a computer program stored therein, the computer program, when executed and performed by a processor, implementing the foregoing method for annotating an event in an application.

In some embodiments, the computer-readable storage medium may include: a read only memory (ROM), a random access memory (RAM), a solid state drive (SSD), an optical disc, and the like. The RAM may include a resistance random access memory (ReRAM) and a dynamic random access memory (DRAM).

In an exemplary embodiment, a computer program product is further provided. The computer program product includes a computer program, the computer program being stored in a computer-readable storage medium. A processor of the computer device reads the computer program from the computer-readable storage medium, and the processor executes the computer program to cause the computer device to perform the foregoing method for annotating an event in an application.

“Plurality of” mentioned in the specification means two or more. The term “and/or” describing an association relationship between associated objects denotes that there can be three relationships. For example, A and/or B can denote: the following three situations: Only A exists, both A and B exist, and only B exists. The character “/” in this specification generally indicates an “or” relationship between the associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are some embodiments of this disclosure, but are not intended to limit this disclosure. Any modification, equivalent replacement, or improvement made within the spirit and principle of this disclosure shall fall within the protection scope of this disclosure.

In this disclosure, during example application of the relevant data and event processing (for example, acquiring, recording, or storing), the informed consent or individual consent of a personal information subject needs to be obtained in strict accordance with the requirements of relevant national laws and regulations (or other legal bases), and the subsequent data use and processing behavior is carried out within the scope of authorization of laws and regulations and the personal information subject.

In this disclosure, for the recognition technologies related to human faces (or other biological features) and during applying of the instances to specific products or technologies, related data collection, use, and processing processes need to comply with national legal and legal requirements. Before face information is collected, information processing rules need to be

notified and informed consent or independent consent (or other legal bases) of a personal information subject need to be solicited. In addition, the face information is processed strictly according to the legal and legal requirements and the personal information processing rules, and related data security is ensured by using technical measures.

What is claimed is:

1. A method for annotating in an application, comprising:
displaying a user interface of an event annotating tool in a browser;
displaying, in response to a start operation for an application experience simulator, a user interface of the application experience simulator in the user interface of the event annotating tool, the application experience simulator being a runtime instance of the application to be analyzed via the annotating in the application;
when the application experience simulator enters an element selection mode, displaying, in response to a selection operation of a first element in the user interface of the application experience simulator, event annotating information related to the first element in the user interface of the event annotating tool, the event annotating information including at least an interaction type and/or a display feature of an element related to the first element; and
annotating, in response to a confirmation operation on the event annotating information, one or more operation events that occur in the application corresponding to the application experience simulator and match the event annotating information.

2. The method according to claim 1, wherein the displaying the event annotating information comprises:
obtaining a first element set from the user interface of the application experience simulator in response to the selection operation of the first element, the first element set comprising a plurality of elements including the first element and at least a similar element that shares a similarity with the first element; and
displaying, in the user interface of the event annotating tool, first selectors respectively for the plurality of elements in the first element set and second selectors for parent elements of the plurality of elements, the event annotating information comprising at least a selector associated with the element, and the selector being configured for annotating the interaction type and/or the display feature of the element.

3. The method according to claim 2, wherein the obtaining the first element set comprises:
obtaining a document object model (DOM) tree corresponding to the user interface of the application experience simulator, the DOM tree indicating a hierarchical relationship among elements in the user interface of the application experience simulator;
searching for at least the similar element based on the DOM tree; and
constructing the first element set based on a search result of the searching.

4. The method according to claim 3, wherein the searching comprises:
obtaining sibling elements of the first element, the sibling elements corresponding to sibling nodes in the DOM tree, the sibling nodes being at a same level as a first node in the DOM tree that corresponds to the first element;
searching at least the similar element from the sibling elements of the first element;
combining the first element and at least the similar element, to obtain the first element set when the searching from the sibling elements is of success;
performing a recursive upward searching in the DOM tree when the searching from the sibling elements is without success, wherein the recursive upward searching replaces the first element with a parent element of the first element, and continues the searching from updated sibling elements of the first element; and
constructing the first element set by using the first element when the recursive upward searching reaches a recursive level threshold without a success, and
the similar element of the first element includes at least one of: a same interaction type as the first element, a same display feature as the first element, a same text content as the first element, and/or a same location in a display area as the first element.

5. The method according to claim 2, further comprising:
performing enhanced displaying on the plurality of elements in the first element set and the parent elements in the user interface of the application experience simulator; and
canceling, in response to a removal operation on a selector associated with a to-be-removed element in the plurality of elements and the parent elements in the user interface of the event annotating tool, the enhanced displaying of the to-be-removed element in the user interface of the application experience simulator.

6. The method according to claim 2, further comprising:
displaying at least a supplementary annotating condition in the user interface of the event annotating tool, the supplementary annotating condition comprising at least one of a page routing parameter and/or specific element text content, the one or more operation events being limited according to the page routing parameter and/or the specific element text content,
wherein in response to a selection operation of a first supplementary annotating condition in at least the supplementary annotating condition, the event annotating information further comprises the first supplementary annotating condition.

7. The method according to claim 1, further comprising:
controlling, in response to an operation to a mode selection control on the user interface of the event annotating tool, the application experience simulator to enter the element selection mode,
wherein when the application experience simulator is in the element selection mode, the application experience simulator disables a responding in the application to an interaction operation in the user interface of the application experience simulator.

8. The method according to claim 7, further comprising:
clearing, in response to an operation on an element reset control in the user interface of the event annotating tool, a current element selection and current event annotating information in the event annotating tool; and
controlling the application experience simulator to exit the element selection mode.

9. The method according to claim 1, wherein:
the displaying the user interface of the application experience simulator comprises:
loading, based on a scenario parameter received in the user interface of the event annotating tool, an online code package of the application in a delivery channel corresponding to the scenario parameter;
running the online code package to obtain the application experience simulator; and
displaying the user interface of the application experience simulator in the user interface of the event annotating tool, and
the start operation for the application experience simulator comprises receiving, by the user interface of the event annotating tool, the scenario parameter.

10. The method according to claim 1, wherein:
the displaying the user interface of the application experience simulator comprises:
loading an online code package of the application;
running the online code package to obtain the application experience simulator; and
displaying, based on a path parameter received in the user interface of the event annotating tool, the user interface of the application experience simulator in the user interface of the event annotating tool, an initial user interface of the application experience simulator matching the path parameter, and
the start operation for the application experience simulator comprises receiving, by the user interface of the event annotating tool, the path parameter.

11. An information processing apparatus, comprising processing circuitry configured to:
display a user interface of an event annotating tool in a browser;
display, in response to a start operation for an application experience simulator of an application for annotating, a user interface of the application experience simulator in the user interface of the event annotating tool, the application experience simulator being a runtime instance of the application to be analyzed via the annotating in the application;
when the application experience simulator enters an element selection mode, display, in response to a selection operation of a first element in the user interface of the application experience simulator, event annotating information related to the first element in the user interface of the event annotating tool, the event annotating information including at least an interaction type and/or a display feature of an element related to the first element; and
annotate, in response to a confirmation operation on the event annotating information, one or more operation events that occur in the application corresponding to the application experience simulator and match the event annotating information.

12. The information processing apparatus according to claim 11, wherein the processing circuitry is configured to:
obtain a first element set from the user interface of the application experience simulator in response to the selection operation of the first element, the first element set comprising a plurality of elements including the first element and at least a similar element that shares a similarity with the first element; and
display, in the user interface of the event annotating tool, first selectors respectively for the plurality of elements in the first element set and second selectors for parent elements of the plurality of elements, the event annotating information comprising at least a selector associated with the element, and the selector being configured for annotating the interaction type and/or the display feature of the element.

13. The information processing apparatus according to claim 12, wherein the processing circuitry is configured to:
obtain a document object model (DOM) tree corresponding to the user interface of the application experience simulator, the DOM tree indicating a hierarchical relationship among elements in the user interface of the application experience simulator;
search for at least the similar element based on the DOM tree; and
construct the first element set based on a search result of the searching.

14. The information processing apparatus according to claim 13, wherein the processing circuitry is configured to:
obtain sibling elements of the first element, the sibling elements corresponding to sibling nodes in the DOM tree, the sibling nodes being at a same level as a first node in the DOM tree that corresponds to the first element;
search at least the similar element from the sibling elements of the first element;
combine the first element and at least the similar element, to obtain the first element set when the searching from the sibling elements is of success;
perform a recursive upward searching in the DOM tree when the search from the sibling elements is without success, wherein the recursive upward searching replaces the first element with a parent element of the first element, and continues the searching from updated sibling elements of the first element; and
construct the first element set by using the first element when the recursive upward searching reaches a recursive level threshold without a success, and
the similar element of the first element includes at least one of: a same interaction type as the first element, a same display feature as the first element, a same text content as the first element, and/or a same location in a display area as the first element.

15. The information processing apparatus according to claim 12, wherein the processing circuitry is configured to:
perform enhanced displaying on the plurality of elements in the first element set and the parent elements in the user interface of the application experience simulator; and
cancel, in response to a removal operation on a selector associated with a to-be-removed element in the plurality of elements and the parent elements in the user interface of the event annotating tool, the enhanced displaying of the to-be-removed element in the user interface of the application experience simulator.

16. The information processing apparatus according to claim 12, wherein the processing circuitry is configured to:
display at least a supplementary annotating condition in the user interface of the event annotating tool, the supplementary annotating condition comprising at least one of a page routing parameter and/or specific element text content, the one or more operation events being limited according to the page routing parameter and/or the specific element text content, and
in response to a selection operation of a first supplementary annotating condition in at least the supplementary annotating condition, the event annotating information further comprises the first supplementary annotating condition.

17. The information processing apparatus according to claim 11, wherein the processing circuitry is configured to control, in response to an operation to a mode selection control on the user interface of the event annotating tool, the application experience simulator to enter the element selection mode; and
when the application experience simulator is in the element selection mode, the application experience simulator disables a responding in the application to an interaction operation in the user interface of the application experience simulator.

18. The information processing apparatus according to claim 17, wherein the processing circuitry is configured to:
clear, in response to an operation on an element reset control in the user interface of the event annotating tool, a current element selection and current event annotating information in the event annotating tool; and
control the application experience simulator to exit the element selection mode.

19. The information processing apparatus according to claim 11, wherein the processing circuitry is configured to:
load, based on a scenario parameter received in the user interface of the event annotating tool, an online code package of the application in a delivery channel corresponding to the scenario parameter;
run the online code package to obtain the application experience simulator; and
display the user interface of the application experience simulator in the user interface of the event annotating tool, and
the start operation for the application experience simulator comprises receiving, by the user interface of the event annotating tool, the scenario parameter.

20. A non-transitory computer-readable storage medium storing instructions which when executed by at least one processor cause the at least one processor to perform:
displaying a user interface of an event annotating tool in a browser;
displaying, in response to a start operation for an application experience simulator of an application for annotating, a user interface of the application experience simulator in the user interface of the event annotating tool, the application experience simulator being a runtime instance of the application to be analyzed via the annotating in the application;
when the application experience simulator enters an element selection mode, displaying, in response to a selection operation of a first element in the user interface of the application experience simulator, event annotating information related to the first element in the user interface of the event annotating tool, the event annotating information including at least an interaction type and/or a display feature of an element related to the first element; and
annotating, in response to a confirmation operation on the event annotating information, one or more operation events that occur in the application corresponding to the application experience simulator and match the event annotating information.
